(19) United States
(12) Patent Application Publication
(10) Pub. No.: US 2013/0055271 A1
(43) Pub. Date: Feb. 28, 2013

(54) APPARATUS AND METHOD FOR CONTROLLING POLLING

(71) Applicants: Jung-Im YOO, Seoul (KR); Jong-In OH, Seoul (KR)

(72) Inventors: Jung-Im YOO, Seoul (KR); Jong-In OH, Seoul (KR)

(73) Assignee: Pantech Co., Ltd., Seoul (KR)

(21) Appl. No.: 13/528,291

(22) Filed: Jun. 20, 2012

(30) Foreign Application Priority Data
Aug. 24, 2011 (KR) 10-2011-0084788

(51) Int. Cl. G06F 9/46

(52) U.S. Cl. 718/102

(57) ABSTRACT

A polling control apparatus includes a scheduler to identify polling applications in an electronic terminal and group together the polling events of the polling applications based on the polling times of the polling applications. A polling application may be in more than one group based on the interval between polling events of the application. A traffic manager of the polling control apparatus manages a data connection between the polling control apparatus and a network to connect the electronic terminal to the network at a polling event start time of the group and maintain the data connection until all polling events in the group are completed. The polling control apparatus may adjust the polling time of applications to be during the data connection or based on an importance parameter of the application.

### CROSS-REFERENCE TO RELATED APPLICATION

This application claims priority from and the benefit under 35 U.S.C. §119(a) of Korean Patent Application No. 10-2011-0084788, filed on Aug. 24, 2011, which is hereby incorporated by reference for all purposes as if fully set forth herein.

### BACKGROUND

1. Field

The present disclosure relates to an electronic terminal, and more particularly, to an automatic update capability of applications in the electronic terminal.

2. Discussion of the Background

Electronic terminals may include smart phones, tablet computers, personal digital assistance (PDAs), etc. An electronic terminal can utilize various application programs and data. The operating system of an electronic terminal characterizes the electronic terminal allowing a user to add, delete, and/or upgrade the operating system itself or application programs of the electronic terminal.

A communication service provider may push upgrade information to the electronic terminal, but the current Android platform does not provide such push services. Instead, the Android platform is provided with upgrade information by performing application polling for updates periodically.

However, applications differ from one another in their polling start time and polling interval. Thus, even when there is no significant difference in polling time, a data connection and disconnection may be recursively performed as a polling time of each application arrives. For example, even in the night when data communication seldom occurs, a terminal may be repeatedly switched between a sleep mode and a wake-up mode for application polling, resulting in unnecessary traffic and battery consumption.

### SUMMARY

Exemplary embodiments of the present invention provide an apparatus and method for controlling polling intervals for upgrading applications used in an electronic terminal.

Additional features of the invention will be set forth in the description which follows, and in part will be apparent from the description, or may be learned by practice of the invention.

An exemplary embodiment of the present invention discloses an apparatus to control application polling in a device, including: a scheduler to identify polling applications in the device and to group together polling events of the polling applications based on the polling times of the applications; and a traffic manager unit to control a first duration of a data connection of the device according to the polling events in a first group.

An exemplary embodiment of the present invention also discloses a method for controlling application polling in a device, including: identifying a first application and a second application in a device as a first polling application and a second polling application, respectively, and the first polling application and the second polling application each performing polling via a polling event; determining a first polling time for the first polling application, and determining a second polling time for the second polling application; determining a first polling interval for the first polling application, and determining a second polling interval for the second polling application; grouping the first polling event with the second polling event in a first group according to the first polling time and the second polling time; establishing a polling event start time for the first group; establishing a data connection of the device to a network at the polling event start time; performing the first polling event and the second polling event; and disconnecting the data connection from the network.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to control polling according to an exemplary embodiment of the present invention.

FIG. 2 is a diagram illustrating group polling events according to an exemplary embodiment of the present invention.

FIG. 3 is a flowchart illustrating a method for grouping polling events according to an exemplary embodiment of the present invention.

FIG. 4 is a flowchart illustrating a method for performing polling according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the sizes and relative sizes of components may be exaggerated for clarity. Like reference numerals in the drawings denote like elements.

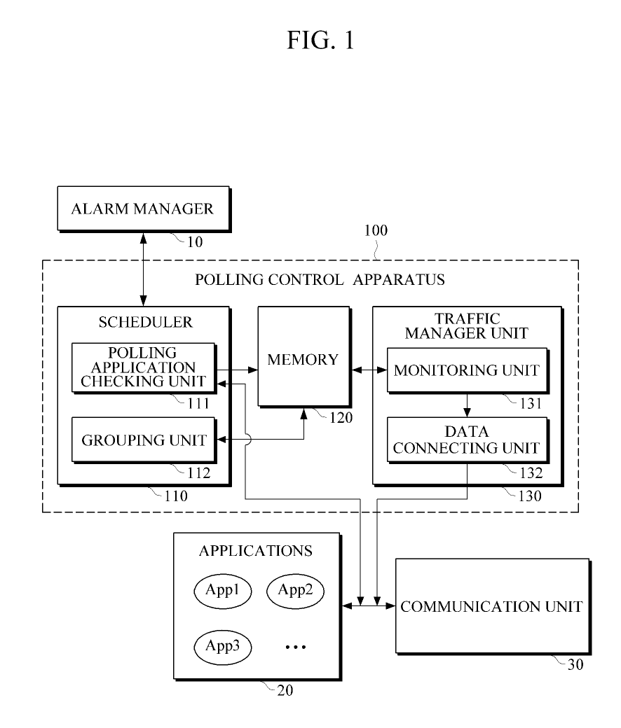

FIG. 1 is a block diagram illustrating an apparatus to control polling according to an exemplary embodiment of the present invention.

Polling refers to checking for the presence of application version update information or new information through the application, such as, the application KakaoTalk®.

An apparatus to control polling may control a polling interval to acquire new information including version updates, new messages, etc., and may be included in an electronic terminal, such as, a smart phone, a personal digital assistant (PDA), a tablet personal computer, or the like, which can execute applications. This apparatus will be described with reference to FIG. 1.

Referring to FIG. 1, the apparatus 100 includes a scheduler 110, a memory 120, and a traffic manager unit 130.

Hereinafter, a “polling application” will refer to an application that performs polling, i.e. an application that checks for the presence of application version update information or new information through the application. The scheduler 110 may detect a polling application, analyze a polling interval of the detected polling application, and group together two or more polling events occurring within a reference time period. The scheduler 110 may include a polling application checking unit 111 and a grouping unit 112.

The polling application checking unit 111 may determine which application performs polling among applications 20 that may be executed on a terminal in which the apparatus 100 is included, and may determine a polling interval of the recognized polling application.

Polling intervals of the polling applications are determined through an alarm manager 10. On the Android platform most applications are updated at regular intervals by use of the alarm manager 10. Thus, the alarm manager 10 stores information about the polling applications and the polling intervals of the polling applications. Accordingly, the polling application checking unit 111 acquires the information about polling applications and their polling intervals from the alarm manager 10.

To determine whether an application performs polling where the information regarding the availability of polling and a polling interval of the application cannot be obtained from the alarm manager 10, the polling application checking unit 111 may analyze a data usage pattern in the framework. An application exhibiting a periodic pattern of data usage may be determined to be a polling application, i.e. an application that performs polling. However, an application having an irregular pattern of the data usage, for example, an application using a data connection which is connected for a longer period of time, may be determined not to be a polling application.

The polling application checking unit 111 may store application identification information identifying the polling applications, a user identification (ID), and a polling interval of each recognized polling application in the memory 120. If obtaining information about a polling interval of a polling application that has not yet been registered in the alarm manager 10, the application checking unit 111 may register the obtained polling interval and polling application in the alarm manager 10.

The grouping unit 112 may analyze a polling interval of each polling application stored in the memory 120 to group together one or more polling events occurring within a similar time period. Where each polling application generates a polling event periodically, the grouping unit 112 may group together the polling events based on time. For example, if a time difference between a polling event of a first polling application and a polling event of a second polling application is smaller than a reference time period, the polling events of the first polling application and the second polling application may be categorized into the same group. A first polling event of a polling application that may have taken place after a longer period of time and a subsequent polling event that occurs within a reference time period from the occurrence of the first polling event may be classified into the same group. Since the grouping unit 112 groups based on the polling events, the polling applications that generate the polling events may belong to more than one group based on the polling interval and polling time of the polling applications.

The grouping unit 112 may adjust a polling time of a polling application to exclude from the group a polling application that may be effected by the polling events of other polling applications in the group. The polling time can be adjusted in the polling applications based on an importance parameter. Polling applications with a low importance parameter, i.e., in which the importance of a real-time data check is relatively low, may be, for example, a social networking service (SNS) applications, a Cyworld® application, or the like. On the other hand, polling applications with a high importance parameter may be polling applications with polling times that cannot be adjusted, for example, messenger applications, such as, KakaoTalk® and Daum My People, and email applications, which may require real-time data check. If the polling time of the polling event of a polling application added to a group by the grouping unit 112 is earlier than a polling event start time of the group, the polling time of the polling application may be matched with the polling event start time of the group. If the adjusted polling time of a polling application added to a group is later than a polling event end time of the group, the polling time of the polling application is changed to the polling event end time of the group. The grouping unit 112 may update the adjusted polling times of the polling applications in the alarm manager 10. In other words, the adjusted polling times are registered in the alarm manager 10. Accordingly, the polling time of the polling applications of a group are adjusted to perform polling between the polling event start time and the polling event end time of the group.

A traffic manager unit 130 may maintain a data connection until all the polling events in the same group are completely performed by the scheduler 110. The traffic manager unit 130 may include a monitoring unit 131 and a data connecting unit 132.

The monitoring unit 131 may compare a polling time of each group stored in the memory 120 with a current time to determine whether the polling time of a group has arrived. If the polling time has arrived, the monitoring unit 131 transmits relevant group information to the data connecting unit 132. The group information may include polling times of two or more polling events, information about the polling applications that generate the polling events, and user ID information of each polling application.

In response to receiving group information from the monitoring unit 131, the data connecting unit 132 may control a communication unit 30 to connect a data connection at the polling event start time of the corresponding group. The data connecting unit 132 maintains the data connection until two or more polling events are completely performed. Once the polling events belonging to the same group no longer need the use of a network, the data connecting unit 132 disconnects the data connection.

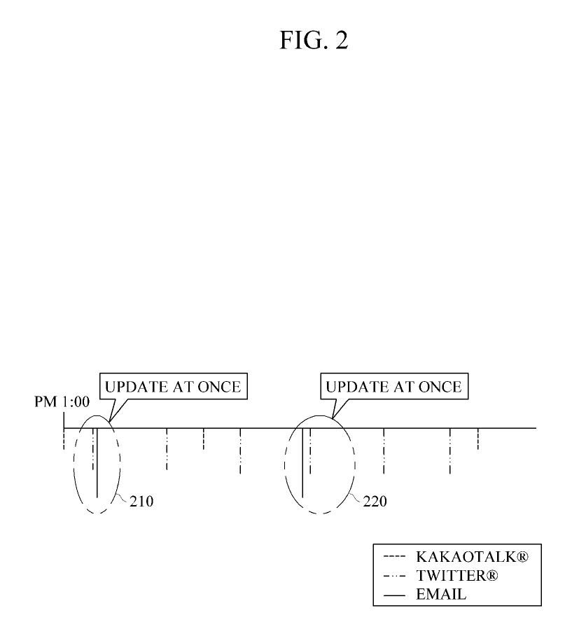

FIG. 2 is a diagram illustrating group polling events according to an exemplary embodiment of the present invention.

Referring to FIG. 2, a KakaoTalk® application may generate a polling event every 10 minutes, and the first polling event occurrence time of the KakaoTalk® application may be 1:00 p.m. A Twitter® application may generate a polling event every 5 minutes, and the first polling event occurrence time of the Twitter® application may be 1:03 p.m. An email application may generate a polling event every 20 minutes, and the first polling event occurrence time of the email application may be 1:04 p.m.

As shown in FIG. 2, the time difference between the polling event occurrence time of the Twitter® application (1:03 p.m.) and the email application (1:04 p.m.) is not significantly large and may be less than a reference time period. Thus, the grouping unit 112 may categorize the Twitter® application polling event at 1:03 p.m. and the email application polling event at 1:04 p.m. into the same group 210. This grouping may avoid the unnecessary recurrence of data connection and disconnection.

Hereinafter, a polling control method by the aforementioned polling control apparatus will be described. The polling control method generally includes two procedures: grouping of polling events and connecting of a data connection for each group to perform polling.

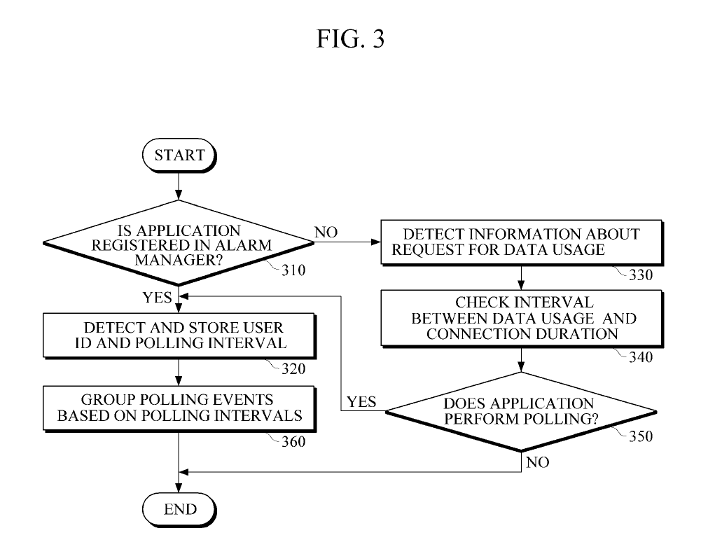

FIG. 3 is a flowchart illustrating a method for grouping polling events according to an exemplary embodiment of the present invention.

Referring to FIG. 3, the scheduler 110 investigates the occurrence of polling and polling interval of each application among Applications 20. In operation 310, the scheduler 110 determines whether the application has been registered in the alarm manager 10.

If the application is registered in the alarm manager 10, the application is determined to be a polling application. In operation 320, the scheduler 110 acquires the user ID and the polling interval of the polling application from the alarm manager 10 and stores the obtained user ID and the polling interval in the memory 120.

However, if the application is not registered in the alarm manager 10, in operation 330, the scheduler 110 detects a data usage request time of the application. A data usage connection time of a network framework is investigated to determine a time interval between requests for data usage and a connection duration. In operation 340, the scheduler 110 checks the time interval between requests for data usage and a connection duration of the application. In operation 350, the scheduler 110 determines whether the application performs polling based on the results of operation 340.

If it is determined that the application performs polling, i.e., performs data connection at regular intervals, the scheduler 110 proceeds to operation 320 since the application is determined to be a polling application.

In contrast, if it is determined that the application does not perform polling, i.e., if the data connection does not occur on a regular basis and a connection duration is greater than a reference duration, the scheduler 110 determines that the application does not perform polling and is not a polling application, and the method terminates.

In operation 360, the scheduler 110 analyzes the stored polling interval of each polling application and groups together a plurality of polling events of various polling applications. Polling events having a difference in their occurrence times less than a reference time period may be grouped together.

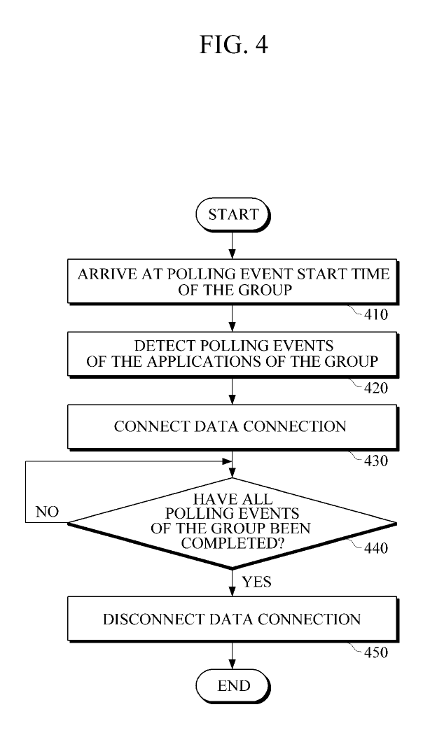

FIG. 4 is a flowchart illustrating a method for performing polling according to an exemplary embodiment of the present invention.

Referring to FIG. 4, in operation 410, the traffic manager unit 130 determines whether a polling time of each group has arrived. In other words, the traffic manager unit 130 determines whether the initial polling event of the group is about to occur. If the polling time of the group has arrived, in operation 420, the traffic manager unit 130 detects the polling applications that generate the polling events belonging to the group and determines the network access ID information of each polling application from the memory 120.

In operation 430, the traffic manager unit 130 may execute a data connection to perform polling. Accordingly, each polling application may perform polling at its own designated polling time. In operation 440, the traffic manager unit 130 determines whether all the polling events belonging to the polling applications of the group have been completed.

If it is determined that the polling events of the group have not yet been completely performed, the traffic manager unit 130 continues to maintain the data connection.

However, if it is determined that the polling applications no longer need to use a network for polling events of the group, in operation 450, the traffic manager unit 130 disconnects the data connection.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to control application polling in a device, comprising:
a scheduler to identify polling applications in the device and to group together polling events of the polling applications according to the polling times of the applications; and
a traffic manager unit to control a first duration of a data connection of the device according to the polling events in a first group.

2. The apparatus of claim 1, wherein the scheduler comprises:
a polling application checking unit to determine if a first application performs polling, and to determine a first polling time of a first polling event of the first application; and
a grouping unit to adjust the first polling time of the first event of the first application, and to group the first polling event of the first application with a second polling event of a second application into the first group according to the first polling time of the first polling event and a second polling time of the second application.

3. The apparatus of claim 1, wherein the traffic manager unit comprises:
a traffic manager unit to determine if a polling time of the first group has arrived; and
a data connecting unit to connect a data connection at a polling event start time of the first group and to end the data connection after the polling events of polling applications in the first group have been completed.

4. The apparatus of claim 1, further comprising a memory to store a user identification and a polling interval for each polling application.

5. The apparatus of claim 2, wherein the grouping unit adjusts the first polling time of the first application to occur at or after a polling event start time of the first group.

6. The apparatus of claim 2, wherein the grouping unit adjusts the first polling time of the first application to be before a polling event end time of the first group.

7. The apparatus of claim 2, wherein the grouping unit adjusts the first polling time of the first application according to an importance parameter of the first application.

8. The apparatus of claim 2, wherein the grouping unit groups the first application in the first group and a third application in a second group, if the third application is effected by the first polling event of the first application.

9. A method for controlling application polling in a device, comprising:
identifying a first application and a second application in a device as a first polling application and a second polling application, respectively, and the first polling application and the second polling application each performing polling via a polling event;
determining a first polling time for the first polling application, and determining a second polling time for the second polling application;
determining a first polling interval for the first polling application, and determining a second polling interval for the second polling application;
grouping the first polling event with the second polling event in a first group according to io the first polling time and the second polling time;
establishing a polling event start time for the first group;
establishing a data connection of the device to a network at the polling event start time;
performing the first polling event and the second polling event; and
disconnecting the data connection from the network.

10. The method of claim 9, wherein grouping further comprises, grouping the first polling event with the second polling event in the first group according to the first polling interval and the second polling interval.

11. The method of claim 9, further comprising:
determining if a third application is registered in the device as a polling application;
if the third application is registered as a polling application:
detecting and storing a user identification and polling interval of the third application; and
if the third application is not registered as a polling application:
receiving data usage information of the third application and a data connection duration of the third application;
determining a third polling interval of the third polling application;
to determining if the third interval is periodic:
if the data connection duration is less than a reference duration, identifying the third application as a third polling application, and storing a user identification of the third polling application and a third polling interval of the third polling application; and
if the data connection duration is greater than a reference duration, identifying the third application as not performing polling.

12. The method of claim 11, wherein if the third interval of the third application is periodic and the data connection duration is less than a reference duration, registering the third application as a polling application in the device.

13. The method of claim 9, further comprising grouping the first polling event with a third polling event in a first group comprising:
determining if a difference between the first polling time of the first application and a third polling time of a third application is less than a reference time period; and
if the difference is less than the reference time period, grouping the first application and the third application together in the first group.

14. The method of claim 9, wherein the first application is also grouped into a second group according to the first polling interval.

15. The method of claim 9, further comprising:
if the first polling time of the first application is before the polling event start time of the first group, adjusting the first polling time of the first application to be on or after the polling event start time.

16. The method of claim 9, further comprising:
if the polling time of the first application is after a polling event end time of the first group, adjusting the polling time of the first application to be before the polling event end time.

17. The method of claim 9, further comprising:
adjusting the polling time of the first application according to an importance parameter of the first application.

18. The method of claim 9, further comprising grouping a third polling event of a third polling application into a second group if the third application is effected by the polling event of the first application.
